(19) United States
(12) Patent Application Publication
(10) Pub. No.: US 2024/0190164 A1
(43) Pub. Date: Jun. 13, 2024

(54) Embossing Roll

(71) Applicant: Paper Converting Machine Company, Green Bay, WI (US)

(72) Inventor: André Seuser, Neuwied (DE)

(21) Appl. No.: 18/527,629

(22) Filed: Dec. 4, 2023

Related U.S. Application Data
(60) Provisional application No. 63/431,150, filed on Dec. 8, 2022.

(51) Int. Cl. B44B 5/00; B44B 5/02

(52) U.S. Cl. CPC B44B 5/0009; B44B 5/026

(57) ABSTRACT

An embossing roll has an embossing region that has a plurality of embossing elements. Each of the embossing elements projects outward from a surface of the embossing roll a distance of about 0.2 mm to about 2.0 mm. The plurality of embossing elements are arranged in the embossing region in a pattern. The plurality of embossing elements has at least a first set of embossing elements and a second set of embossing elements. The first set of embossing elements has a first shape and the second set of embossing elements has a second shape that is different from the first shape.

### RELATED APPLICATION DATA

This application claims priority benefit to U.S. provisional application Ser. No. 63/431,150, filed Dec. 8, 2022, the disclosure of which is incorporated by reference herein.

### BACKGROUND AND SUMMARY

The present disclosure is directed to an embossing roll, and more in particular, an embossing roll for micro embossing. More in particular, the present disclosure is directed to a micro embossing roll that is specifically configured with multifunctional properties to provide a web material with desired physical and aesthetic properties. In one aspect, the embossing roll has a mix of different embossing element shapes. By providing a distribution of different embossing shapes in a pattern in a embossing region of the embossing roll, the embossing roll may condition the web with more precise physical and aesthetic properties.

In conventional processing, the standard is to micro emboss a back sheet or sheets using only one dedicated embossing element shape and element height. These dedicated shapes can improve a property of the final product. The density of the distribution of embossing elements on the embossing roll may vary depending upon the desired physical property to be imparted to the web material.

The present disclosure is directed to mixing the embossing element shapes and heights in the pattern of the embossing region of the single embossing roll to improve, balance or control various product physical and aesthetic properties at the same time. The web materials to be embossed using the methodology can include, by way of example and not in any limiting sense, tissue, non-woven materials, or other formable fibrous or non-fibrous products. The web materials to be embossed can be moistened, lotioned or heated, or may be dry prior to embossing. As described below, the plurality of embossing elements may include one set of embossing elements which have a shape that is configured with a focus on improving softness of the final product, and another set of embossing elements of the plurality of embossing element may have another shape that is configured with a focus on improving bulk to the final product. The differences between the shapes of embossing elements of the first and second sets of embossing elements may include differences in any number of geometric features of the embossing element, for instance, height, side wall angle, top side size, top side shape, radii of the transition between the side wall and the top side, radii of the transition between the side wall and the floor of the depression between adjacent elements. The distribution, mix, or density of embossing elements with the first and second shapes may vary proportionally by percentage or numbers. The different embossing elements may be distributed individually or in groups in a pattern within the embossing region of the roll. The number of set of embossing elements with different geometric features may be two or more. The embossing rolls may be engraved chemically, by conventional machining (tooling) methods and/or via direct laser.

### DESCRIPTION OF THE DRAWINGS

FIG. 1 is a front view of an exemplary embossing roll.

FIG. 2 is an enlarged detail area of an embossing region of the embossing roll of FIG. 1 showing a pattern of embossing elements.

FIG. 3 is a further enlarged detail area of the pattern of FIG. 2 showing a representative embossing element of one set of the embossing elements in the pattern of the embossing region of the embossing roll.

FIG. 4 is a further enlarged detail area of the pattern of FIG. 2 showing a representative embossing element of another set of the embossing elements in the pattern of the embossing region of the embossing roll.

FIG. 5 is a further enlarged detail area of the pattern of FIG. 2 showing a representative embossing element of yet another set of the embossing elements in the pattern of the embossing region of the embossing roll.

FIG. 6 is a front view of another embodiment of an exemplary embossing roll showing an embossing region with discontinuous areas.

FIG. 7 is an enlarged detail area of an embossing region of the embossing roll of FIG. 6 showing a further example of a pattern of embossing elements.

FIG. 8 is a front view of yet another embodiment of an exemplary embossing roll showing an embossing region with discontinuous areas covering less than a majority of an outer surface of embossing roll.

FIG. 9 is an enlarged detail area of an embossing region of the embossing roll of FIG. 8 showing a further example of a pattern of embossing elements.

FIG. 10 is an enlarged cross sectional view showing embossing elements of an exemplary embossing roll against a rubber roll in a micro embossing process.

FIG. 11 is an enlarged cross sectional view showing embossing elements of one embossing roll in a nested arrangement with embossing elements of a like configured embossing roll for a nested micro embossing process.

FIG. 12 is an enlarged cross sectional view showing embossing elements of one embossing roll in a tip to tip arrangement with embossing elements of a like configured embossing roll for a tip to tip micro embossing process.

FIG. 13 is an exemplary radar chart comparing patterns and their effect on paper properties.

### DETAILED DESCRIPTION

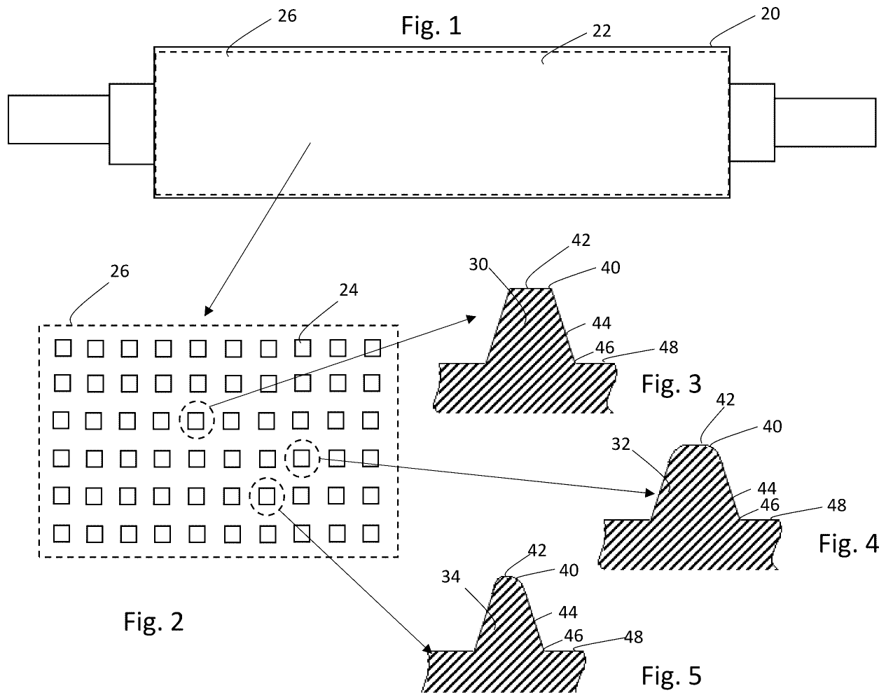

FIGS. 1, 6 and 8 show examples of embossing rolls 20, 120, 220 for micro embossing in accordance with the following disclosure. Each of the rolls 20, 120, 220 has an embossing region 22, 122, 222 with a plurality of embossing elements 24, 124, 224 arranged in a pattern 26, 126, 226 for micro embossing a web of material. The embossing elements 24, 124, 224 may project outward from an outer surface of the embossing roll 20, 120, 220 a distance of about 0.2 mm to about 2.5 mm. The distance of projection of the embossing elements 24, 124, 224 may vary as desired so as to impart a desired physical and aesthetic property to the web. The exemplary roll for micro embossing may be used in connection with processing of a web that is laminated with another web to form the product. In connection therewith, the micro embossed web may form the bottom of the product with the top of the product having a decorative pattern produced by traditional macro embossing techniques. In the alternative, the micro embossed web may form the top of the product.

Or in yet another alternative, the micro embossed web may be the sole web in the product. Or in yet another alternative, the micro embossed pattern may be provided in the background on the same embossing roll as a decorative macro embossing pattern, at the same height as the decorative pattern, or at a different height than the decorative pattern.

The plurality of embossing elements 24, 124, 224 are arranged in the embossing region in a pattern 26, 126, 226. By way of example and not in any limiting sense, FIGS. 2, 7 and 9 provide examples of embossing regions 22, 122, 222 and patterns 26, 126, 226 that may be employed. By way of example and not in any limiting sense, the embossing region 22 may comprise the entire outer surface of the embossing roll (FIG. 2), the embossing region 122 may comprise substantially all or a majority of the outer surface of the embossing roll (FIG. 7), or the embossing region 222 may comprise a minority of the outer surface of the embossing roll (FIG. 9). The embossing region 22 may comprise a continuous area on the outer surface of the embossing roll, for instance, as shown in FIG. 2, or the embossing region 122, 222 may comprise at least two discontinuous areas on the embossing roll 120, 220, for instance, as shown in FIGS. 7 and 9. The discontinuous areas may be arranged symmetrically on the embossing roll, for instance, as shown in FIGS. 7 and 9. The pattern 126, 226 of the embossing elements in one of the discontinuous areas may match the pattern 126, 226 of the embossing elements in the other of the discontinuous areas, for instance, as shown in FIGS. 7 and 9.

Within the embossing region, the pattern 26, 126, 226 may include an arrangement where each embossing element 24, 124, 224 of the plurality of embossing elements is equidistantly spaced from an adjacent embossing element. In the examples shown in FIGS. 2, 7 and 9, each embossing element 24, 124, 224 of the plurality of embossing elements is equidistantly spaced from an adjacent embossing element in a direction parallel or with a skew to a center axis of the embossing roll. A pattern with a skew has elements arranged substantially parallel to the center axis of the embossing roll, with a slight angle so that an entire row of embossing elements does not enter an embossing nip simultaneously, which can result in vibration and noise. Also, in the examples shown in FIGS. 2, 7 and 9, each embossing element 24, 124, 224 of the plurality of embossing elements is equidistantly spaced from an adjacent embossing element in a circumferential direction. In the examples shown in FIGS. 2, 7, and 9, the pattern 26, 126, 226 of the embossing region 22, 122, 222 comprises rows of embossing elements that are aligned in a direction parallel to a center axis of the embossing roll where each embossing element in the row is equidistantly spaced from an adjacent embossing element in the row in the direction parallel to the center axis of the embossing roll. In the drawings, the skew has been eliminated for ease of illustration. In the example of FIG. 2, the adjacent rows and columns are evenly spaced and the distribution of embossing elements 24 on the outer surface of the embossing roll is uniform within the embossing region 22 that covers the entire outer surface of the embossing roll. In the example of FIG. 7, the adjacent rows and columns are evenly spaced, but one row of embossing elements 124 is axially offset from a circumferentially adjacent row of embossing elements and one circumferential column of embossing elements is circumferentially offset from an axially adjacent circumferential column of embossing elements. In the example of FIG. 9, the pattern 226 comprises embossing elements 224 in adjacent rows and columns that are evenly spaced with no offset within the embossing region 222 that comprises discontinuous areas in the shape of waves on the outer surface of the embossing roll 220. It should be appreciated that various embossing region(s) and pattern(s) may be used on the outer surface of the embossing roll as desired to impart aesthetic and physical properties to the web.

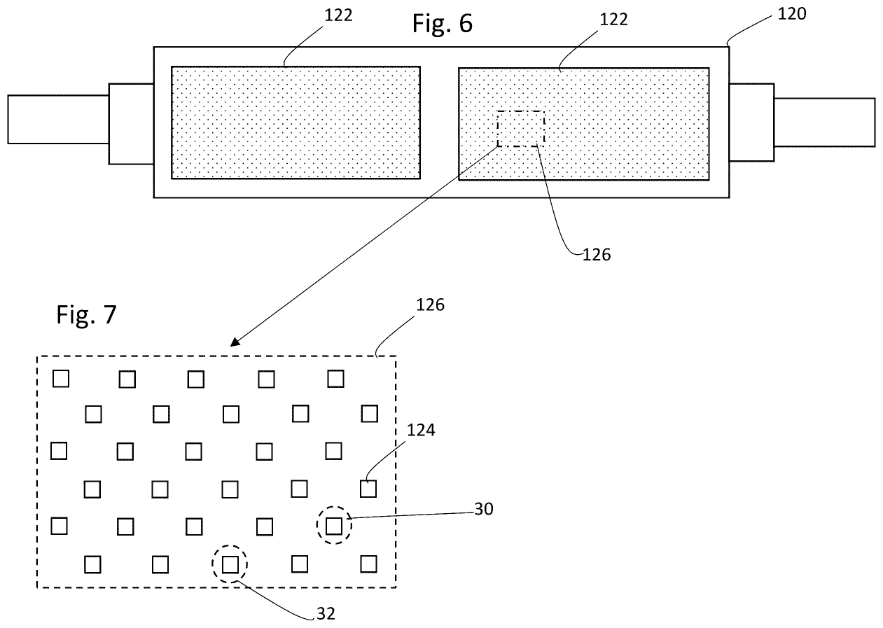

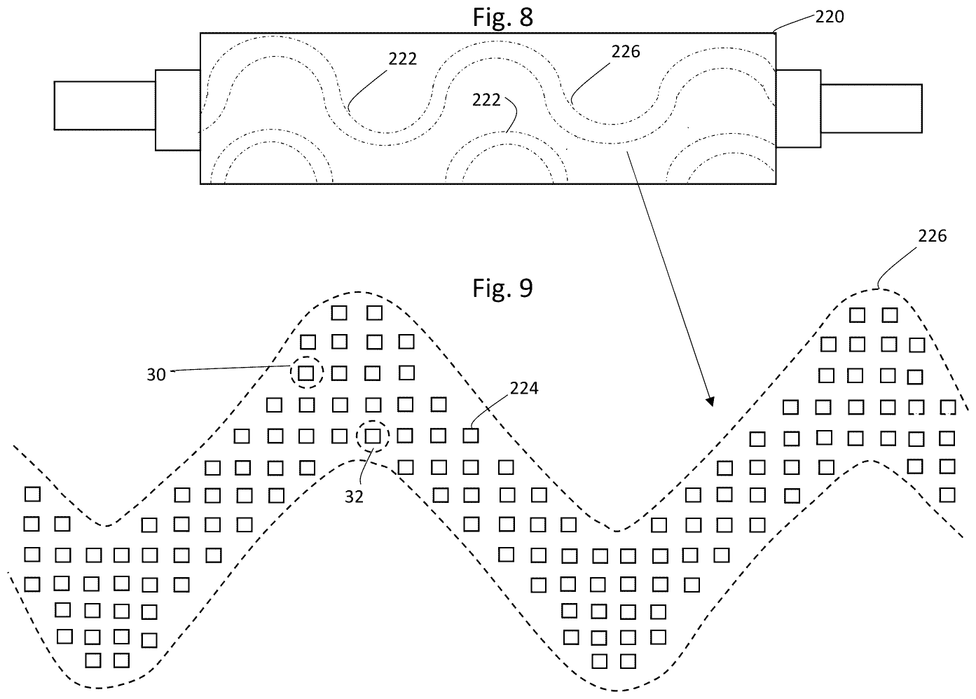

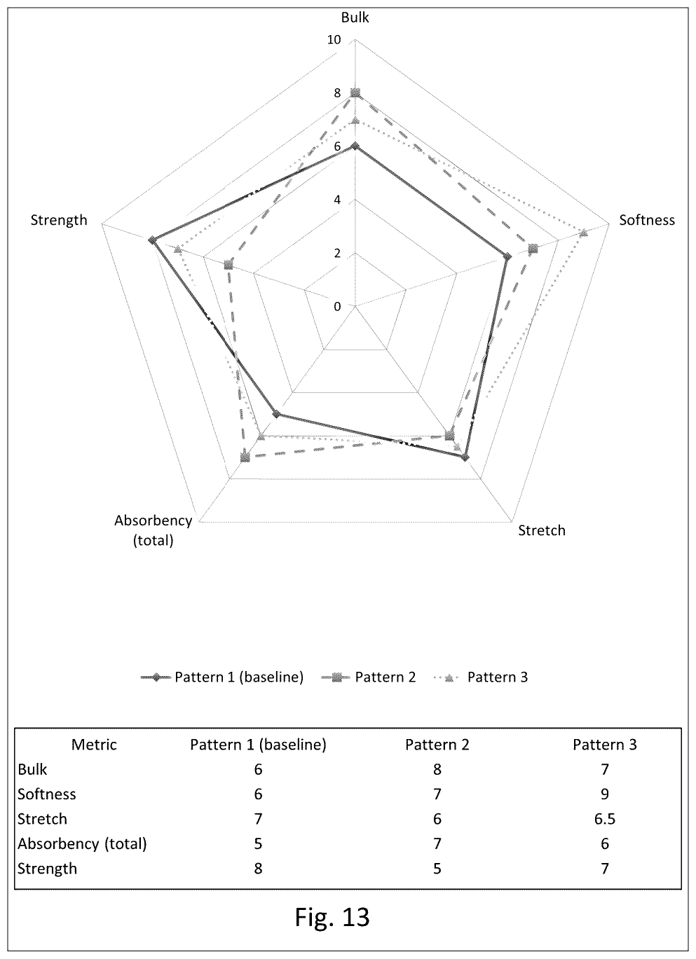

Within the pattern 26, 126, 226 in the embossing region 22, 122, 222, the plurality of embossing elements 24, 124, 224 may comprise at least two different sets of embossing elements. One set of embossing elements may have a shape different from a shape of the other set embossing elements. For instance, FIGS. 3-5 show representative embossing elements 30, 32, 34 of three sets of embossing elements 24 within the pattern 26 of the embossing region 22 of the embossing roll. In the example shown by FIGS. 3-5, the representative embossing elements 30, 32, 34 have the same general height but varying radii 40 between a top side 42 and a side wall 44 of the respective representative embossing element. The representative embossing element 30 shown in FIG. 3 has a relatively small radius 40 between the top side 42 and the side wall 44 and may be distributed within the pattern as desired in order to increase the bulk of the product. The representative embossing elements shown in FIGS. 4 and 5, respectively, have an increasing radii 40 between the top side 42 and the side wall 44 and may be distributed within the pattern as desired in order to increase the softness of the product. The use of differently shaped embossing elements 124, 224 may be used in the patterns 126, 226 of the embossing regions 122, 222 of the embossing rolls 120, 220 of FIGS. 6 and 8. The general shape of the embossing elements 24, 124, 224 may comprise a truncated round cone with varying radii among the sets of embossing elements. Embossing may reduce the tensile strength of a web. An element with a larger radius 40 may reduce the tensile strength of a web to a lesser degree than an element with a smaller radius 40—in other words, a web may be stronger after embossing with a pattern with an element with a larger radius than it would be after embossing with a pattern with an element with a smaller radius. An element with a larger radius 40 may result in a softer web with a smaller reduction in tensile strength compared to an element with a smaller radius 40. An element with a smaller radius 40 may result in a web with more bulk and a larger reduction in tensile strength compared to an element with a larger radius 40. The general shape of the embossing elements 24, 124, 224 may also comprise a diamond shaped top side with varying top side surface area among the sets of embossing elements. The distribution of embossing elements 24, 124, 224 and the number of sets of embossing elements may be varied as desired to tailor the softness and bulk of the final product as desired. The differences between the shapes of embossing elements 24, 124, 224 of the sets of embossing elements may include differences in any number of geometric features of the embossing element, for instance, height, side wall angle, top side size (diameter of round elements, area of round or non-round elements), top side shape, radii of the transition between the side wall and the top side, radii of the transition between the side wall and the floor of the depression between adjacent elements. The distribution, mix, or density (in number of embossing elements per unit area, or in total length of element top edge perimeter per unit area) of embossing elements with the different shapes may vary proportionally by percentage or numbers within the pattern. The different embossing elements 24, 124, 224 may be distributed individually or in groups in the pattern 26, 126, 226 within the embossing region 22, 122, 222 of the embossing roll 20, 120, 220. Side wall angles 44 may be in the range of about 10 degrees to about 25 degrees per side. Top side 42 size may be in the range of about 0.09 square millimeters to about 6.0 square millimeters (a diameter of about 0.3 millimeters to about 2.5 millimeters for round elements). Top side shapes may be round, oval, diamond, rectangular, square, triangular, or a combination of these and/or other multi-sided shapes. The radii 40 of the transition between the side wall and the top side may range from about 0.05 millimeters to about 0.30 millimeters. The radii 46 of the transition between the side wall 44 and the floor 48 of the depression between adjacent elements may range from about 0.05 millimeters to about 3.0 millimeters. The densities of embossing elements may range from about 10 elements per square centimeter to about 100 elements per square centimeter. The density of embossing element top edge per unit area may comprise the range driven by the combination of ranges of other properties. FIG. 13 provides an exemplary radar chart showing how three patterns may be varied with embossing element density to affect material properties of the web.

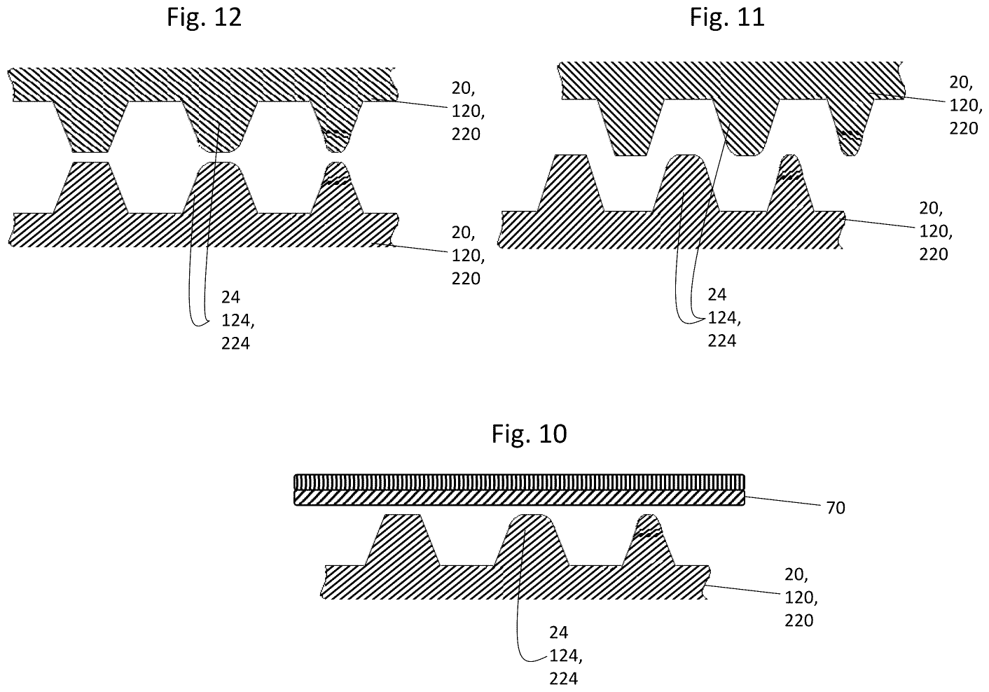

In a micro embossing process, the embossing roll 20, 120, 220 may be operated opposite of a rubber or steel platen roll 70, for instance, as shown in FIG. 10. In the alternative, for instance, as shown in FIGS. 11 and 12, in the micro embossing process, two like embossing rolls 20, 120, 220 as described above may be provided. In one aspect as shown in FIG. 11, the like embossing rolls 20, 120, 220 may be aligned in a manner such that the embossing elements are nested. The term “nested” refers to a pattern where the depressions created between adjacent embossing element 24, 124, 224 on a first side of the web are in register with the embossing elements 24, 124, 224 created on the second opposite side of the web, and vice-versa. Thus, a nested embossing pattern can be created with two embossment rolls, each having embossment elements and the embossment elements of one roll mesh between the embossment elements of the other roll. In yet another alternative, for instance, as shown in FIG. 12, in the micro embossing process, two like embossing rolls as described above may be aligned in a manner such that the embossing elements 24, 124, 224 are tip to tip. Thus, each embossing element of one roll contacts an embossing element of the opposing roll at the nip of the rolls during each revolution.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

What is claimed is:

1. An embossing roll comprising:
an embossing region, the embossing region having a plurality of embossing elements, each of the embossing elements in the plurality of the embossing elements projecting outward from a surface of the embossing roll a distance of about 0.2 mm to about 2.0 mm, the plurality of embossing elements being arranged in the embossing region in a pattern, the plurality of embossing elements having at least a first set of embossing elements and a second set of embossing elements, the first set of embossing elements having a first shape, the second set of embossing elements having a second shape, the first shape being different from the second shape.

2. The embossing roll of claim 1 wherein each embossing element of the plurality of embossing elements is equidistantly spaced from an adjacent embossing element in a direction substantially parallel to a center axis of the embossing roll within the pattern of the embossing region.

3. The embossing roll of claim 1 wherein each embossing element of the plurality of embossing elements is equidistantly spaced from an adjacent embossing element in a circumferential direction within the pattern of the embossing region.

4. The embossing roll of claim 1 wherein the pattern of the embossing region comprises rows of embossing elements, the rows of embossing elements being aligned in a direction substantially parallel to a center axis of the embossing roll, each embossing element in the row being equidistantly spaced from an adjacent embossing element in the row in the direction substantially parallel to the center axis of the embossing roll.

5. The embossing roll of claim 4 wherein one row of embossing elements is axially offset from a circumferentially adjacent row of embossing elements.

6. The embossing roll of claim 4 wherein the embossing elements in the row comprise embossing elements with the first shape and embossing elements with the second shape.

7. The embossing roll of claim 1 wherein the pattern of the embossing region comprises circumferential columns of embossing elements, the circumferential columns of embossing elements being aligned circumferentially in a direction perpendicular to a center axis of the embossing roll, each embossing element in the circumferential column being equidistantly spaced from an adjacent embossing element in the circumferential column in the direction perpendicular to the center axis of the embossing roll.

8. The embossing roll of claim 7 wherein one circumferential column of embossing elements is circumferentially offset from an axially adjacent circumferential column of embossing elements.

9. The embossing roll of claim 7 wherein the embossing elements in the circumferential column comprise embossing elements with the first shape and embossing elements with the second shape.

10. The embossing roll of claim 1 wherein the embossing region comprises a majority of an outer surface of the embossing roll.

11. The embossing roll of claim 1 wherein the embossing region comprises an entire outer surface of the embossing roll.

12. The embossing roll of claim 1 wherein the first shape of the first set of embossing elements is adapted and configured to soften a web of material being embossed with the embossing roll, and the second shape of the second set of embossing elements is adapted and configured to increase the bulk of the web of material being embossed with the embossing roll.

13. The embossing roll of claim 1, wherein the embossing region comprises at least two discontinuous areas on the embossing roll.

14. The embossing roll of claim 13 wherein the discontinuous areas are arranged symmetrically on the embossing roll.

15. The embossing roll of claim 13 wherein the pattern of the embossing elements in one of the discontinuous areas matches the pattern of the embossing elements in the other of the discontinuous areas.

16. The embossing roll of claim 1 wherein one of the first and second shape comprises a truncated round cone.

17. The embossing roll of claim 1 wherein one of the first and second shape comprises a diamond shape.

18. The embossing roll of claim 1 wherein the embossing elements are formed by chemical etching.

19. The embossing roll of claim 1 wherein the embossing elements are formed by machining tooling.

20. The embossing roll of claim 1 wherein the embossing elements are formed with a laser.
